(19) United States
(12) Patent Application Publication
(10) Pub. No.: US 2016/0081873 A1
(43) Pub. Date: Mar. 24, 2016

(54) EXERCSING EQUIPMENT AND A METHOD FOR SPINAL ADJUSTMENT OR SPINAL MANIPULATION

(71) Applicant: THOMAS W SIMS, OWENSBORO, KY (US)

(72) Inventor: THOMAS W SIMS, OWENSBORO, KY (US)

(21) Appl. No.: 14/631,868

(22) Filed: Feb. 26, 2015

Related U.S. Application Data
(60) Provisional application No. 62/053,173, filed on Sep. 21, 2014.
(60) Provisional application No. 62/088,643, filed on Dec. 7, 2014.

(51) Int. Cl. A61H 15/00; A61H 1/02; A61H 1/00

(52) U.S. Cl. CPC A61H 15/0092; A61H 1/008; A61H 1/0292; A61H 2015/0014

(57) ABSTRACT

The embodiments herein provide an exercising equipment and a method for spinal adjustment or spinal manipulation without causing compression or pressure on other body parts of a user. The equipment comprises a freely moving padded roller that is attached to a hollow pipe, a strap, and a handle. The user of the equipment lays on the padded roller and exerts pressure on the targeted area by pushing up on the handles with arms. Further, the user moves the roller up and down the spine by popping/adjusting each vertebrae. The equipment adjusts user's spine thoracic and upper lumbar area, in a more natural position, by using user's own body weight along with the force exerted by the user on the equipment. The equipment manipulates spinal vertebras of the user without sending all the exerted pressure through the internal organs, body cavity, rib cage and sternum.

### CROSS-REFERENCE TO RELATED APPLICATION

The embodiments herein claim the priority of the U.S. Provisional Patent Applications with Ser. Nos. 62/053,173 filed on Sep. 21, 2014 and 62/088,643 filed on Dec. 7, 2014 and the contents of which are incorporated by reference herein.

### BACKGROUND

1. Technical Field

The embodiments herein are generally related to an exercising and home fitness equipment. The embodiments herein are particularly related to a Do-it-yourself exercising equipment or personal exercise equipment for spinal adjustment or spinal manipulation. The embodiments herein are more particularly related an exercising equipment and a method for eliminating aches, pains, and pinched nerves from the spine, without causing compression or pressure to other body parts such as internal organs, body cavity, rib cage and sternum.

2. Description of the Related Art

The human spinal column is a major component of the skeletal system, with several bones such as cervical vertebrae, thoracic vertebrae, lumbar vertebrae, sacral vertebrae and coccyx vertebrae. The individual vertebrae are connected and supported by various cartilages, muscles and ligaments which allow flexibility for bending and twisting of the torso. When subjected to stresses or typical aging, the spinal column lose normal contour and the interior structure of the disc degenerates or ruptures leading to a displacement of the intra-disc cushioning material.

Unassisted exercises for abdomen, and spine often must be performed in postures that are less than optimal for desired isolation and effect. For example, when a force is applied to manipulate the thoracic and upper lumbar areas of the spine by using a medical machine or by a chiropractor, the force travels through the cavity of the body and compress internal organs, rib cage and the sternum which causes unwanted or unneeded stress on the body.

A variety of stationary spine adjustors/devices have been developed to assist people in whole body or chiropractic messages. Traditional foam rollers, and ab/back rollers, which are available in the market, are made for stretching and strengthening the spine. Thus, the existing equipment are used only for stretching and strengthening the spine. These exercising equipment does not allow the users to adjust the spine in a fashion as a chiropractor. Further, such stationary spine adjustors/devices are designed as large equipment and are expensive to buy.

Hence there is a need for an exercising equipment and a method for spinal adjustment and eliminating aches, pains, and pinched nerves from the spine of a person without sending all the exerted pressure through the internal organs, body cavity, rib cage and sternum. Further, there is need for a do-it-yourself exercising equipment or a personal exercising equipment or a home based personal exercising equipment and a method for manipulating spinal vertebras of a person by using a spine adjustment roller. Furthermore, there is also a need for an exercising equipment to adjust spine thoracic and upper lumbar area of a user, in a more natural position, by using user's own body weight along with the force exerted by the user on the equipment.

The above mentioned shortcomings, disadvantages and problems are addressed herein and which will be understood by reading and studying the following specification.

### OBJECT OF THE EMBODIMENTS

The primary object of the embodiments herein is to provide an exercising equipment and a method for eliminating aches, pains, and pinched nerves from the spine of a user, without causing compression or pressure to other body parts such as internal organs, body cavity, rib cage and sternum.

Another object of the embodiments herein is to provide a portable, do-it-yourself exercising equipment or a personal exercising equipment or a home based personal exercising equipment and a method for spinal adjustment or spinal manipulation using a reverse pressure lumbar adjustment roller.

Yet another object of the embodiments herein is to provide an exercising equipment to adjust a spine thoracic and upper lumbar area of a user, in a more natural position, by using the user's own body weight along with the force exerted by the user on the equipment.

Yet another object of the embodiments herein is to provide a do-it-yourself exercising equipment or a personal exercising equipment or a home based personal exercising equipment to adjust and manipulate the user's spine in a standing posture or in a sitting posture, according to an embodiment of the present invention.

These and other objects and advantages of the embodiments herein will become readily apparent from the following detailed description taken in conjunction with the accompanying drawings.

### SUMMARY

The following details present a simplified summary of the embodiments herein to provide a basic understanding of some aspects of the embodiments herein. This summary is not an extensive overview of the embodiments herein. It is not intended to identify key/critical elements of the embodiments herein or to delineate the scope of the embodiments herein. Its sole purpose is to present some concept of the embodiments herein in a simplified form as a prelude to the more detailed description that is presented later.

The various embodiments herein provide an exercise equipment comprising a lumbar adjustment roller, a hollow pipe and a strap with at least two handles. The lumbar adjustment roller is configured to glide along a spinal length of a user. The hollow pipe is placed inside a cavity provided in the roller. The strap is slid or slidably moved through a hollow space provided inside the hollow pipe. The lumbar adjustment roller is placed against a target area on a user's body. The user rolls on the lumbar adjustment roller by pushing forward the handles using a pair of arms. The movement of the roller on the user's body exerts a force on the targeted area of the user's body, thereby adjusting each vertebrae of the spinal to provide a relief to a plurality of spine muscles, ligaments and nerves.

According to an embodiment herein, the handles are attached to both ends of the strap with the help of a plurality of stitches.

According to an embodiment herein, the length of the strap is adjustable, wherein the strap is stretched as the handles are pulled by the user.

According to an embodiment herein, the strap exerts a force on the roller and the force is transferred to the target area of the user's body.

According to an embodiment herein, the handles are pulled in a particular direction to provide a movement to the roller in the respective direction.

According to an embodiment herein, the position of the lumbar adjustment roller is moved or changed along the length of the strap.

According to an embodiment herein, the reverse pressure lumbar adjustment roller is attached to a surface as a permanent or temporary fixture.

According to an embodiment herein, one of the sides of the strap is attached with a plurality of handle. Each handle has a different size. The size of the plurality of handles are mutually different to each other.

According to an embodiment herein, the exercise equipment is used in a lying exercise position.

The various embodiments herein provide an exercise equipment comprising a lumbar adjustment roller configured to glide along a spinal length of a user; and a handle configured to provide a support to a user. The roller and the handle are fixed at a particular position.

According to an embodiment herein, the lumbar adjustment roller is placed against a target area on a user's body.

According to an embodiment herein, the user holds the handle and applies a pressure on the targeted area.

According to an embodiment herein, the pressure exerted on the targeted area of the user's body adjusts each vertebrae of the spinal to provide a relief to a plurality of spine muscles, ligaments and nerves.

According to an embodiment herein, the equipment is used in a standing exercise position and a sitting exercise position.

According to an embodiment herein, the exercise equipment is configured to provide a self-adjustment, alignment, and manipulation of the vertebrae of the user's spinal.

The various embodiments herein provide a method for providing a spinal adjustment using an exercise equipment, the method comprising steps of: positioning a lumbar adjustment roller of the exercise equipment against a target area of a user's body; adjusting a length of the strap placed in a hollow pipe according to the user's preference; pushing at least two handles of the strap upwards with arms and applying a reverse pressure on the targeted area through the roller; and moving the roller on the target area of the user's body thereby adjusting each vertebrae of the spinal for providing a relief to a plurality of spine muscles, ligaments and nerves.

According to an embodiment herein, the method further comprises a step of providing a plurality of adjustable levels of targeted compression by controlling the pressure applied on the handles of the roller.

According to an embodiment herein, the exercise position is one of standing, sitting and lying position.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a front side perspective view of a reverse pressure lumbar adjustment roller, according to an embodiment herein.

FIG. 2 illustrates a front side perspective view of a padded roller with a hollow pipe, according to an embodiment herein.

FIG. 3 illustrates a side view of the padded roller with a hollow pipe, according to an embodiment herein.

FIG. 4 illustrates a front side view of a padded roller, according to an embodiment herein.

FIG. 5 illustrates a front side view of a strap of the reverse pressure lumbar adjustment roller with handles, according to an embodiment herein.

FIG. 6 illustrates a flow chart explaining a method for spinal adjustment or spinal manipulation without causing compression or pressure to other body parts, according to an embodiment herein.

FIG. 7 illustrates a front view of a handle that is used for sending exerted force to the spine, in a standing posture, according to an embodiment herein.

FIG. 8 illustrates a view of a door frame for spine adjustment or spine manipulation by using a handle and a padded roller, in the standing posture, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an exercise equipment comprising a lumbar adjustment roller, a hollow pipe and a strap with at least two handles. The lumbar adjustment roller is configured to glide along a spinal length of a user. The hollow pipe is placed inside a cavity provided in the roller. The strap is slid or slidably moved through a hollow space provided inside the hollow pipe. The lumbar adjustment roller is placed against a target area on a user's body. The user rolls on the lumbar adjustment roller by pushing forward the handles using a pair of arms. The movement of the roller on the user's body exerts a force on the targeted area of the user's body, thereby adjusting each vertebrae of the spinal to provide a relief to a plurality of spine muscles, ligaments and nerves.

According to an embodiment herein, the handles are attached to both ends of the strap with the help of a plurality of stitches.

According to an embodiment herein, the length of the strap is adjustable, wherein the strap is stretched as the handles are pulled by the user.

According to an embodiment herein, the strap exerts a force on the roller and the force is transferred to the target area of the user's body.

According to an embodiment herein, the handles are pulled in a particular direction to provide a movement to the roller in the respective direction.

According to an embodiment herein, the position of the lumbar adjustment roller is moved or changed along the length of the strap.

According to an embodiment herein, the reverse pressure lumbar adjustment roller is attached to a surface as a permanent or temporary fixture.

According to an embodiment herein, one of the sides of the strap is attached with a plurality of handle. Each handle has a different size. The size of the plurality of handles are mutually different to each other.

According to an embodiment herein, the exercise equipment is used in a lying exercise position.

The various embodiments herein provide an exercise equipment comprising a lumbar adjustment roller configured to glide along a spinal length of a user; and a handle configured to provide a support to a user. The roller and the handle are fixed at a particular position.

According to an embodiment herein, the lumbar adjustment roller is placed against a target area on a user's body.

According to an embodiment herein, the user holds the handle and applies a pressure on the targeted area.

According to an embodiment herein, the pressure exerted on the targeted area of the user's body adjusts each vertebrae of the spinal to provide a relief to a plurality of spine muscles, ligaments and nerves.

According to an embodiment herein, the equipment is used in a standing exercise position and a sitting exercise position.

According to an embodiment herein, the exercise equipment is configured to provide a self-adjustment, alignment, and manipulation of the vertebrae of the user's spinal.

The various embodiments herein provide a method for providing a spinal adjustment using an exercise equipment, the method comprising steps of: positioning a lumbar adjustment roller of the exercise equipment against a target area of a user's body; adjusting a length of the strap placed in a hollow pipe according to the user's preference; pushing at least two handles of the strap upwards with arms and applying a reverse pressure on the targeted area through the roller; and moving the roller on the target area of the user's body thereby adjusting each vertebrae of the spinal for providing a relief to a plurality of spine muscles, ligaments and nerves.

According to an embodiment herein, the method further comprises a step of providing a plurality of adjustable levels of targeted compression by controlling the pressure applied on the handles of the roller.

According to an embodiment herein, the exercise position is one of standing, sitting and lying position.

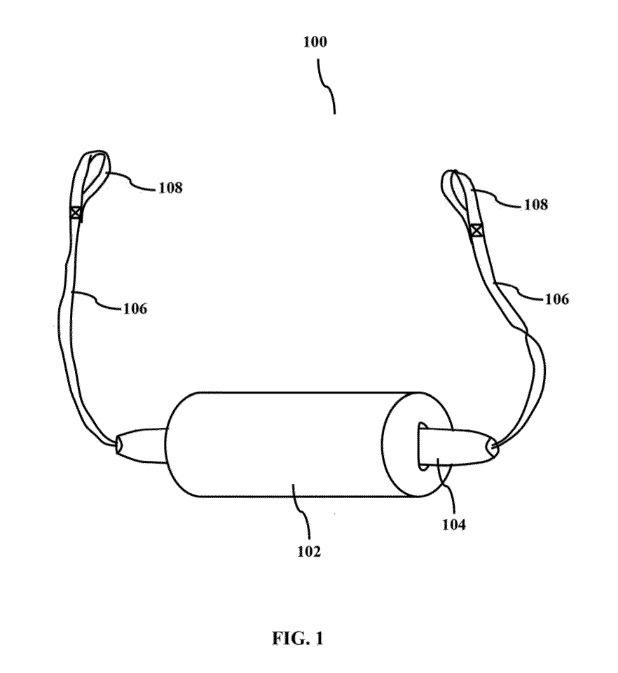

FIG. 1 illustrates a front view of a reverse pressure lumbar adjustment roller 100, according to an embodiment herein. The reverse pressure lumbar adjustment roller 100 comprises a padded roller 102, a hollow pipe 104, and a strap 106 with at least two handles 108. The padded part of roller 102 is made of a polymer material such as, but not limited to, polyurethane, polyethylene, closed-cell foam, rubber and the like materials. The hollow pipe 104 is placed inside a cavity provided in the roller. The padded roller 102 is independent of all other parts and rolls freely on the hollow pipe 104.

The hollow pipe 104 is made of a synthetic plastic polymer material, preferably Poly Vinyl Chloride (PVC). The hollow pipe 104 and is tapered towards both ends. The strap 106 is attached to the hollow pipe 104 at both the ends of the pipe. The length of the strap 106 is adjustable and handles 108 are attached to both ends of the strap 106 by stitches. The handles 108 allow a user to hold the reverse pressure lumbar adjustment roller 100 in a position and apply forward pressure from the arms by pushing up or pulling down the handles 108. The position of the padded roller 102 is movable along the length of the strap 106.

The reverse pressure lumbar adjustment roller 100 allows the user to adjust the vertebrae's of the spine by using the user's body weight along with a force exerted by the upper torso muscles on the padded roller 102. The exerted force is sent directly to the padded roller 102 and then to the targeted area of the user.

According to an embodiment herein, the reverse pressure lumbar adjustment roller 102 is attached as an after-market attachment or manufactured as a permanent fixture to Pilate tables, exercising machines, inversion tables, massage tables and the like.

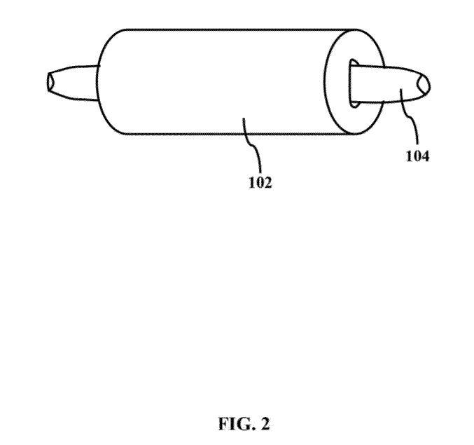

FIG. 2 illustrates a front view of the padded roller 102 with the hollow pipe 104, according to an embodiment herein. The padded roller 102 is independent of all other parts and rolls freely on the hollow pipe 104. The padded roller 102 allows the user to stretch, self-adjust, align and manipulate vertebrae of the spine. The user lays on the padded roller 102 and exerts pressure on the targeted area by pushing up on the handles 108 with user arms.

According to an embodiment herein, the padded roller 102 is separated from the strap 106 and is used for adjusting the spine in a standing position or in a sitting position. The user adjusts or manipulates the targeted area by placing the padded roller 102 in the targeted area.

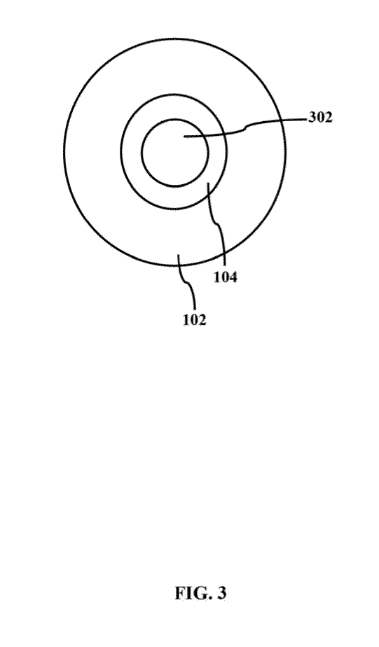

FIG. 3 illustrates a side view of a padded roller 102 with hollow pipe 104, according to an embodiment herein. The padded roller 102 slides over the hollow pipe 104. A hollow space 302 is provided inside the pipe 104 for sliding the strap 106 through the pipe 104.

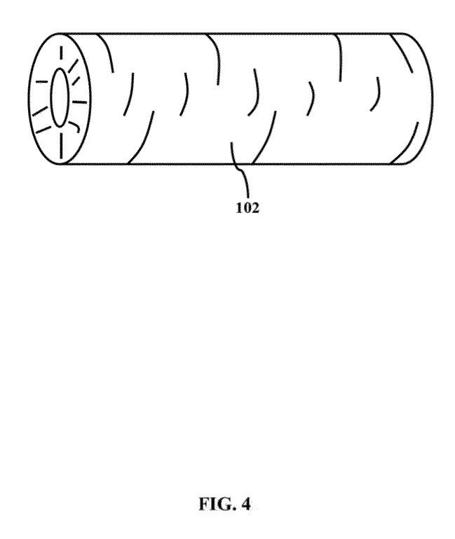

FIG. 4 illustrates a front view of a padded roller 102, according to an embodiment herein. The specific design of the padded roller 102, the strap 106 and the handles 108 allow the user to adjust the spine by using the user's own body weight along with the reverse pressure derived from the user.

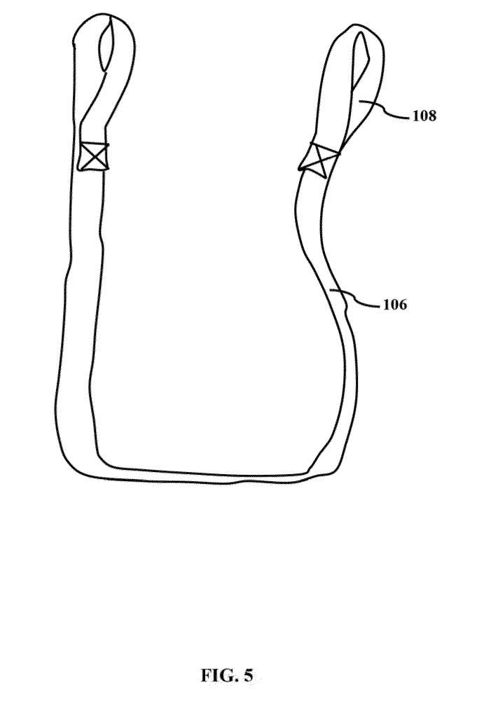

FIG. 5 illustrates a front view of a strap 106 of the reverse pressure lumbar adjustment roller 100 with handles 108, according to an embodiment herein. The handles 108 are attached to both ends of the strap 106 by stitches. The attached handles 108 allow the user to apply reverse pressure to the spine by pushing the user arms upwards on the handles 108.

According to an embodiment herein, one of the sides of the strap 106 is attached with multiples handles for fitting different size users in the reverse pressure lumbar adjustment roller 100.

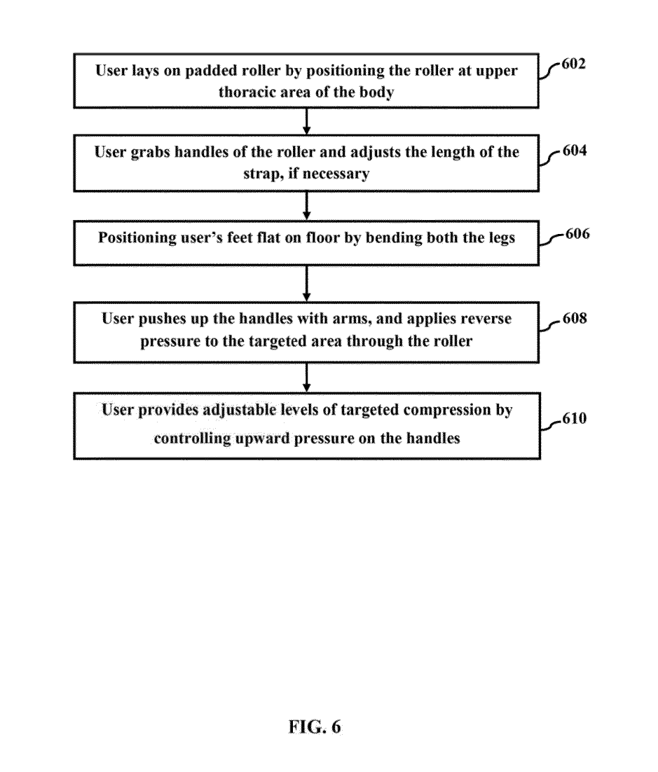

FIG. 6 illustrates a flow chart explaining a method for spinal adjustment or spinal manipulation without causing compression or pressure to other body parts, according to an embodiment herein. Initially, a user lays on the padded roller by positioning the padded roller on a desired trouble area of the body (602). After positioning the padded roller on the appropriate area, the user grabs the handles of the reverse pressure lumbar adjustment roller and adjusts the length of the strap, if necessary (604). The length of the strap is adjusted such that the user arms are bent at an angle suitable for pushing the handles forward. Later, the user's feet are positioned flat on the floor by bending both the legs at suitable angle (606).

The user pushes the handles of the roller upwards with arms and applies reverse pressure to the targeted area through the padded roller (608). While the user pushes the handles upwards, the position of the legs slightly assist the roller to move slowly down the upper thoracic and upper lumbar area of the user body. By pushing up the handles with arms, the user applies reverse pressure to the spine through the padded roller. The upward pressure applied by the arms of the user also assists the roller to move slowly down the spine. The body weight of the user is directed towards the padded roller. Further, when the user tries to lift the body upwards by pushing the arms, the padded roller exerts enough force to adjust the mid to upper spine safely and correctly. The body weight of the user works against the force exerted by the upper torso muscles and allows the user to adjust the vertebrae's of the spine. The user adjusts the levels of targeted compression by controlling the applied pressure or force on the handles of the reverse pressure lumbar adjustment roller (610).

According to an embodiment herein, the reverse pressure lumbar adjustment roller is also used to adjust or manipulate the spine of a user in stand up position or in a seated position, without causing compression or pressure on other body parts.

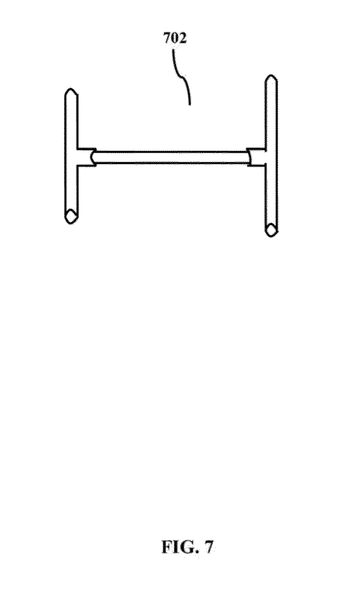

FIG. 7 illustrates a front view of a handle 702 that is used for sending exerted force to the spine, in a standing posture, according to an embodiment herein. The handle 702 is attached to a bracket that fits snugly on the opposite side of a doorframe. The design of the handle 702 allows the user to stand up or sit in a more natural position and apply reverse pressure on targeted area.

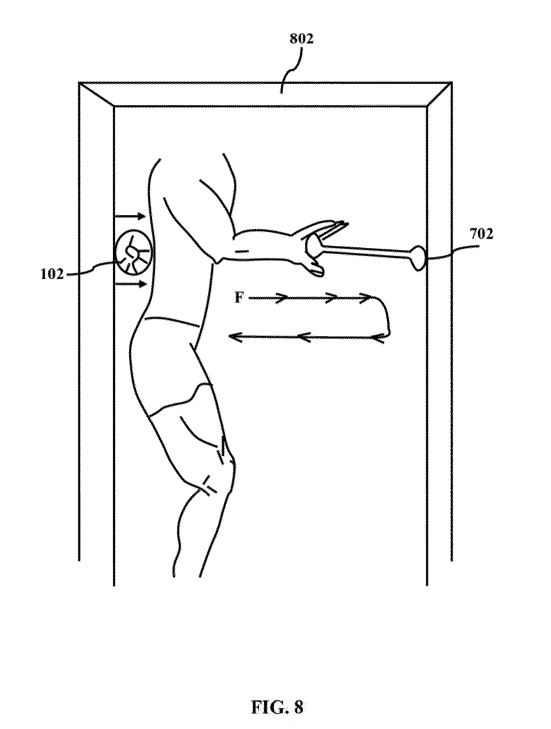

FIG. 8 illustrates a view of spine adjustment or spine manipulation by using the handle 702 and the padded roller 102, in a standing posture, according to an embodiment herein. The reverse pressure lumbar adjustment roller 100 is separated into two pieces without the strap 106. The design allows the user to stand up or sit in a more natural position and apply reverse pressure in the targeted area as shown in the FIG. 8. The user's body is positioned on the doorframe 802 by holding the roller 102 in the targeted area. Further, the user holds the handle 702 and applies forward or reverse pressure on the targeted area. When the user pushes the hands against the handle, the exerted reverse force is sent directly to the padded roller and then delivered to the targeted area.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An exercise equipment comprising:
a lumbar adjustment roller configured to glide along a spinal length of a user;
a hollow pipe placed inside a cavity provided in the roller; and
a strap with at least two handles, wherein the strap is slid through a hollow space provided inside the hollow pipe;
wherein the lumbar adjustment roller is placed against a target area on a user's body, and wherein the user rolls on the lumbar adjustment roller by pushing forward the handles using a pair of arms, and wherein a movement of the roller on the user's body exerts a force on the targeted area of the user's body, thereby adjusting each vertebrae of the spinal to provide a relief to a plurality of spine muscles, ligaments and nerves.

2. The exercise equipment according to claim 1, wherein the handles are attached to both ends of the strap with the help of a plurality of stitches.

3. The exercise equipment according to claim 1, wherein the length of the strap is adjustable, wherein the strap is stretched as the handles are pulled by the user.

4. The exercise equipment according to claim 1, wherein the strap exert the force on the roller and the force is transferred to the target area of the user's body.

5. The exercise equipment according to claim 1, wherein the handles are pulled in a particular direction to provide a movement to the roller in the respective direction.

6. The exercise equipment according to claim 1, wherein the position of the lumbar adjustment roller is movable along the length of the strap.

7. The exercise equipment according to claim 1, wherein the reverse pressure lumbar adjustment roller is attached to a surface as a permanent or temporary fixture.

8. The exercise equipment according to claim 1, wherein one of the sides of the strap is attached with a plurality of handles, each handle with a different size.

9. The exercise equipment according to claim 1, wherein the rollers are used in a lying exercise position.

10. An exercise equipment comprising:
a lumbar adjustment roller configured to glide along a spinal length of a user; and
a handle configured to provide a support to a user,
wherein the roller and the handle are fixed at a particular position.

11. The exercise equipment according to claim 10, wherein the lumbar adjustment roller is placed against a target area on a user's body.

12. The exercise equipment according to claim 10, wherein the user holds the handle and applies a pressure on the targeted area.

13. The exercise equipment according to claim 10, wherein the pressure exerted on the targeted area of the user's body adjusts each vertebrae of the spinal to provide a relief to a plurality of spine muscles, ligaments and nerves.

14. The exercise equipment according to claim 10, wherein the equipment is used in a standing exercise position and a sitting exercise position.

15. A method for providing a spinal adjustment using an exercise equipment, the method comprising steps of:
positioning a lumbar adjustment roller of the exercise equipment against a target area of a user's body;
adjusting a length of the strap placed in a hollow pipe according to the user's preference;
pushing at least two handles of the strap upwards with arms and applying a reverse pressure on the targeted area through the roller; and
moving the roller on the target area of the user's body thereby adjusting each vertebrae of the spinal for providing a relief to a plurality of spine muscles, ligaments and nerves.

16. The method according to claim 15, further comprises adjusting a compression force to a plurality of levels of targeted compression by controlling a pressure applied on the handles of the roller.

17. The method according to claim 15, wherein the exercise position is one of standing, sitting and lying positions.
